(19) United States
(12) Patent Application Publication
(10) Pub. No.: US 2007/0259536 A1
(43) Pub. Date: Nov. 8, 2007

(54) Communication Connector

(75) Inventors: Jon Darin Long, Ogden, UT (US); Damian Riddoch, Ogden, UT (US)

Correspondence Address: FISH & RICHARDSON PC, P.O. BOX 1022, MINNEAPOLIS, MN, 55440-1022, US

(73) Assignee: RSGA INTERNATIONAL, INC., Ogden, UT (US)

(21) Appl. No.: 11/684,099

(22) Filed: Mar. 9, 2007

Related U.S. Application Data
(60) Provisional application No. 60/780,501, filed on Mar. 9, 2006.

(51) Int. Cl. H01R 11/30

(52) U.S. Cl. 439/39

(57) ABSTRACT

A communication connector assembly includes a first connector and a second connector configured to receive the first connector. The first connector includes a first connector body and at least one communication contact supported by the first connector body. The second connector includes a second connector body defining a contact surface configured to receive the first connector and at least one communication contact supported by the second connector body. The communication contact is configured to receive the corresponding communication contact of the first connector. At least one magnet is supported by at least one of the first and second connector bodies and is configured to magnetically retain the first and second connector bodies together.

This U.S. patent application claims priority under 35 U.S.C. 119(e) to a U.S. provisional patent application filed on Mar. 9, 2006, entitled “MAGNETIC BREAK AWAY ELECTRICAL CONNECTOR” and having assigned Ser. No. 60/780,501, the entire contents of which are hereby incorporated by reference.

### TECHNICAL FIELD

This disclosure relates to communication connectors.

### BACKGROUND

A communication connector is a device for joining two communication channels. One example of a communication connector is an electrical connector joining two electrical circuits together. The connection may be temporary or permanent. Plug and socket connectors are usually made up of a male plug and a female socket, although hermaphroditic connectors exist as well. Plugs generally have one or more pins or prongs that are inserted into one or more openings in the mating socket. The connection between the mating parts generally must be sufficiently tight to make a good electrical connection and complete the circuit.

### SUMMARY

Communication connectors generally cannot accommodate non-axial loading and sudden impacts without experiencing damage or transferring excessive loads to the circuit board (or device containing the circuit board) and causing damage to the circuit board (or device containing the circuit board). Non-axial forces may cause the device to undergo a break-away or quick-disconnect rather than transfer potentially damaging loads into the circuit board or device. These forces may be transferred into the communication connector damaging the communication connector, an attached cable, or the device into which the communication connector is mounted.

In one aspect, a communication connector assembly includes a first connector and a second connector configured to receive the first connector. The first connector includes a first connector body and at least one communication contact supported by the first connector body. The second connector includes a second connector body defining a contact surface configured to receive the first connector and at least one communication contact supported by the second connector body. The communication contact is configured to receive the corresponding communication contact of the first connector. At least one magnet is supported by at least one of the first and second connector bodies and is configured to magnetically retain the first and second connector bodies together.

In another aspect, a communication connector assembly includes a first connector and a second connector configured to receive the first connector. The first connector includes a central communication contact and an outer communication contact supported by the central communication contact. Each communication contact of the first connector is insulated from the other. The second connector includes a second connector body defining a receptacle configured to receive the first connector. A central communication contact is supported by the second connector body in the receptacle and is configured to receive the central communication contact of the first connector. At least one magnet is supported by the second connector body and is configured to electrically contact the outer communication contact of the first connector such that the magnet magnetically retains the second connector to the first connector.

Implementations of this aspect of the disclosure may include one or more of the following features. In some implementations, the communication contacts of the first connector are concentric with each other along a longitudinal axis defined by the first connector. In some examples, the first connector and the receptacle are each substantially conically shaped, hemi-spherically shaped or some other curved shape.

In some implementations, the first and second connectors each include at least one middle contact. The middle communication contact of the first connector is supported by the central contact and insulated from the other communication contacts. In some implementations, the communication contacts are concentric with each other along a longitudinal axis defined by the receptacle. The middle communication contact of the second connector is supported by the second connector body and is configured in the receptacle to receive the corresponding middle communication contact of the first connector. The middle communication contact is insulated from the other communication contacts of the second connector. In some implementations, the communication contacts of the second connector are concentric with each other along the longitudinal axis.

The central communication contact of the second connector, in some instances, includes a contact head configured to receive the central communication contact of the first connector and a contact spring or other force applying mechanism (elastomeric material or magnets). The contact spring engages the contact head against the central communication contact of the mating first connector, thereby maintaining communication contact between the two and allowing relatively looser tolerances in the communication connector assembly. Both the contact head and spring are retained by the second connector body. In some examples, the contact head is integral with the spring.

In some examples, the first or second connector is electrically joined to a male or female audio connector. In other examples, the first or second connector is electricity joined to a male or female universal serial bus connector.

In another aspect, a communication connector assembly includes a first connector and a second connector configured to receive the first connector. The first connector includes a magnetically attractable first connector housing and at least one connector stem extending from the first connector housing. Each connector stem includes a central communication contact and at least one outer communication contact supported by the central communication contact. Each communication contact of the first connector is insulated from the other. The second connector includes a second connector housing defining at least one receptacle configured to receive the corresponding connector stem of the first connector. A central communication contact is supported by the second connector housing in each receptacle and is configured to receive the central communication contact of the corresponding connector stem of the first connector. At least one outer communication contact is supported by the second connector housing in each receptacle and is configured to receive the outer communication contact of the corresponding connector stem of the first connector. At least one magnet is supported by the second connector housing and is configured to magnetically retain the second connector to the first connector.

In some implementations, the communication contacts of each connector stem of the first connector are concentric with each other along a longitudinal axis defined by the connector stem. Also, in some implementations, the communication contacts of each receptacle of the second connector are concentric with each other along a longitudinal axis defined by each receptacle. In some examples, each connector stem and corresponding receptacle is substantially conically shaped.

The central communication contact of each receptacle of the second connector, in some instances, includes a contact head configured to receive the central communication contact of a corresponding connector stem of the first connector and a contact spring. The contact spring engages the contact head against the central communication contact of the mating connector stem, thereby maintaining communication contact between the two and allowing relatively looser tolerances. Both the contact head and spring are retained in the corresponding receptacle of the second connector housing. In examples having three or more poles, an annular contact located about half way up the connector contacts a second spring in the mating connector.

The magnetic temporary retention of the second connector to the first connector allows a quick break away of each connector due to sudden impacts or non-axial loading.

The communication contacts of the communication connector assembly may include electrical contacts, optical contacts, or other types joining communication.

The details of one or more implementations of the disclosure are set fourth in the accompanying drawings and the description below. Other features, objects, and advantages will be apparent from the description and drawings, and from the claims.

### DESCRIPTION OF DRAWINGS

FIG. 1A-B are perspective views of a communication connector.

FIG. 2 is a perspective view of a communication connector.

FIG. 3 is an exploded view of a communication connector.

FIG. 4 is an exploded view of a communication connector.

FIG. 5 is an exploded view of a communication connector.

FIG. 6 is an exploded view of a communication connector.

FIG. 7 is an exploded view of a communication connector.

FIG. 8 is a front view of a first connector of a communication connector.

FIG. 9 is a front view of a second connector of a communication connector.

Like reference symbols in the various drawings indicate like elements.

### DETAILED DESCRIPTION

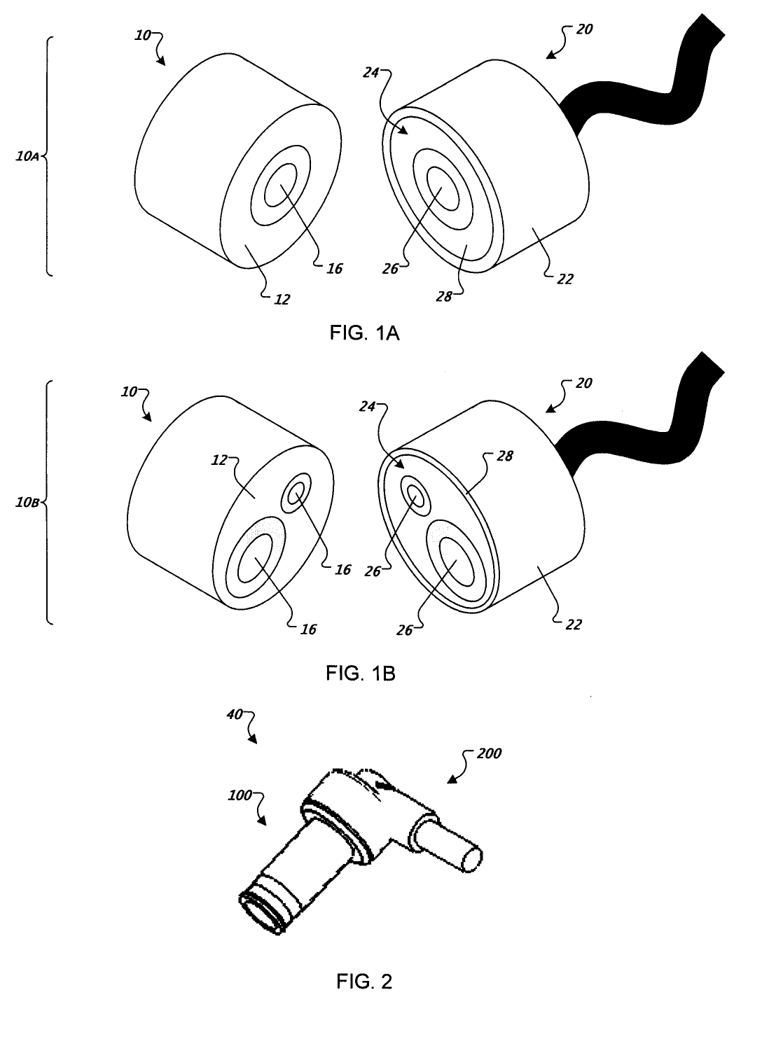

Referring to FIGS. 1A-B, a communication connector assembly 1, 2 includes a first connector 10 and a second connector 20 configured to receive the first connector 10. The first connector 10 includes a first connector body 12 and at least one communication contact 16 supported by the first connector body 12. The second connector 20 includes a second connector body 22 defining a contact surface 24 configured to receive the first connector 10 and at least one communication contact 26 supported by the second connector body 20. The first and second connector bodies, 12 and 22, respectively, may be magnetically attractable. The communication contact 26 is configured to receive the corresponding communication contact 16 of the first connector 10. At least one magnet 28 is supported by at least one of the first and second connector bodies 12 and 22, respectively, and is configured to magnetically retain the first and second connector bodies, 12 and 22, respectively, together. In one example, the second connector body 22 supports the magnet 28 configured to magnetically engage the magnetically attractable first connector body 12 to retain the second connector 20 to the first connector 10. In some examples, as shown in FIG. 1B, the magnet 28 may act as a communication channel for power or signals. Although the communication contacts 16, 26 are depicted as circular, they may define any shape (e.g. rectangular, elliptical, trapezoidal, triangular etc.).

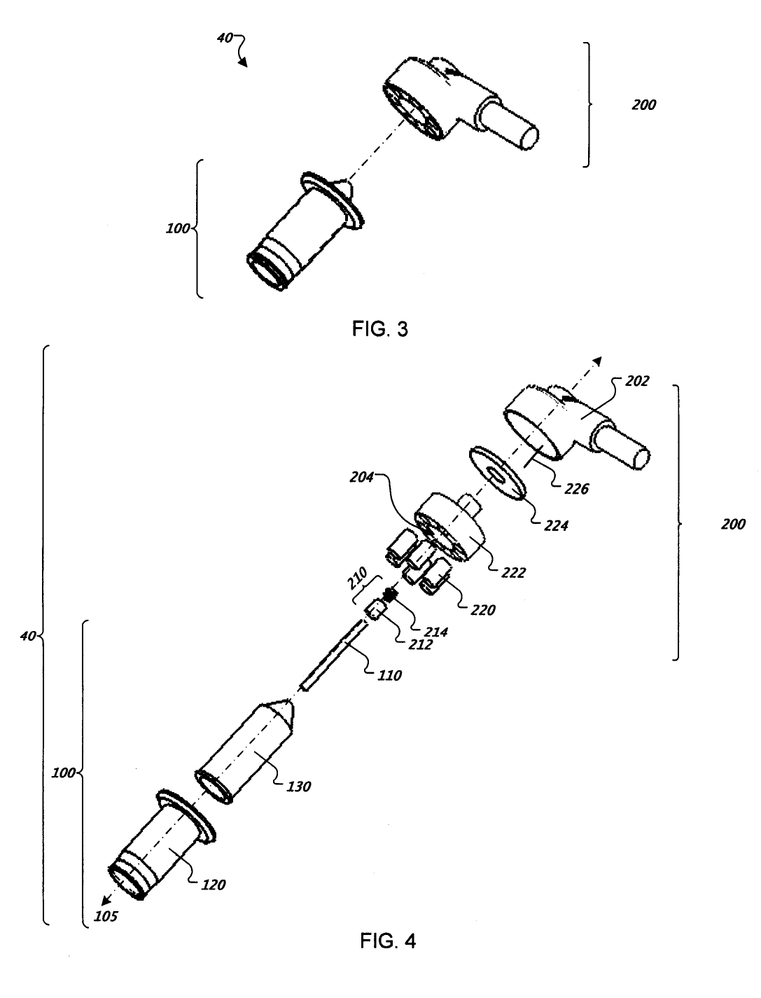

Referring again to FIGS. 2-4, a communication connector assembly 40 includes a first connector 100 and a second connector 200 configured to receive the first connector 100. The first connector 100 includes a central communication contact 110 and an outer communication contact 120 supported by the central communication contact 110. Each communication contact 110, 120 is insulated from the other with an insulator 130. In some implementations, the communication contacts 110, 120 of the first connector 100 are concentric with each other along a longitudinal axis 105 defined by the first connector 100. In some examples, the first connector 100 is substantially conically shaped. Other shapes are possible as well, including hemi-spherical, pyramidal, wedged, and trapezoidal blocks.

The second connector 200 includes a second connector body 202 defining a receptacle 204 configured to receive the first connector 100. In some examples, the receptacle 204 is substantially conically shaped. For example, a male conical plug received by a female conically shaped socket. In some instances, the second connector body 202 defines a bent shape (e.g. a right angle socket). A central communication contact 210 is supported by the second connector body 202 in the receptacle 204 and is configured to receive the central communication contact 110 of the first connector 100. At least one magnet 220 is supported by the second connector body 202 and is configured to electrically contact the outer communication contact 120 of the first connector 100 such that the magnet 220 magnetically retains the second connector 200 to the first connector 100. The magnet 220 may receive or transmit either power or a data signal to the attached outer communication contact 120 of the first connector 100. In some examples, the magnets 220 may be replaced with a single magnetic contact surface rather than separate smaller magnets. In some examples, the second connector body 202 includes a magnet holder 222 to retain and/or position the magnet 220. Also, in some examples, the second connector body 202 includes a contact plate 224 in contact with the magnet 220 and a communication lead 226 to transmit power or a signal from the communication lead 226 to the magnet 220. Upon contact with the outer communication contact 120 of the first connector 100, the magnet 220 transmits power or the signal to the outer communication contact 120.

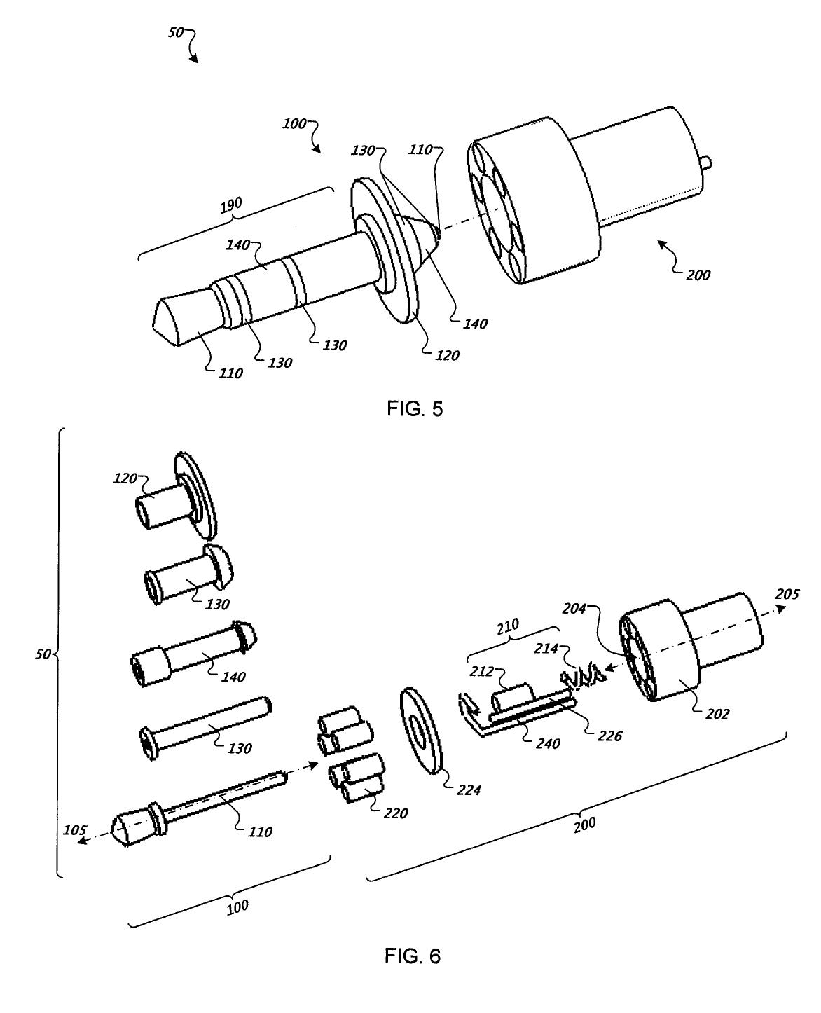

Referring to FIGS. 5-6, in some implementations, the first and second connectors, 100 and 200 respectively, of a communication connector assembly 50 each include at least one middle contact 140 and 240 respectively. The middle communication contact 140 of the first connector 100 is supported by the central contact 110 and insulated from the other communication contacts 110, 120 by an insulator 130. In some implementations, the communication contacts 110, 120, 140 are concentric with each other along a longitudinal axis 205 defined by the receptacle 204. The middle communication contact 240 of the second connector 200 is supported by the second connector body 202 and is configured in the receptacle 204 to receive the corresponding middle communication contact 140 of the first connector 100. The middle communication contact 240 is insulated from the other communication contacts 210, 220 of the second connector 200. In some implementations, the communication contacts 210, 240 are concentric with each other along the longitudinal axis 205. In applications with multiple communication contacts, the magnet 220 may be used as only a retention device rather than to receive or transmit either power or a data signal to the attached outer communication contact 120 of the first connector 100.

The central communication contact 210 of the second connector 200, in some instances, includes a contact head 212 configured to receive the central communication contact 110 of the first connector 100 and a contact spring 214. The contact spring 214 engages the contact head 212 against the central communication contact 110 of the mating first connector 100, thereby maintaining communication contact between the two and allowing relatively looser tolerances in the communication connector assembly 50. Both the contact head 212 and spring 214 are retained by the second connector body 202.

In some examples, as shown in FIG. 5, the first connector 100 or the second connector 200 is electricity joined to a male audio connector 190. In one instance, as shown in FIG. 6, the central communication contact 110, middle communication contacts 120, outer communication contact 120, and insulators 130 define shapes corresponding to each respective part of the audio connector 190 extending from and integral with the first connector 100. In other examples, the first connector 100 or the second connector 200 is electricity joined to a male universal serial bus (USB) connector.

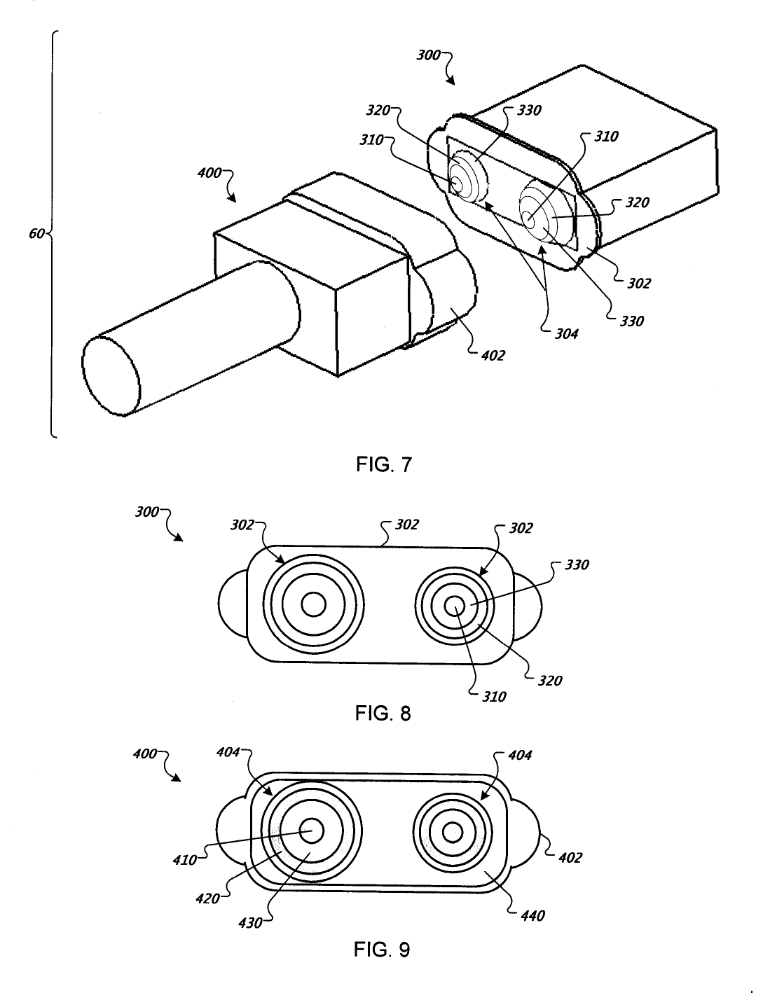

Referring to FIGS. 7-9, a communication connector assembly 60 includes a first connector 300 and a second connector 400 configured to receive the first connector 300. Referring to FIG. 8, the first connector 300 includes a magnetically attractable first connector housing 302 and at least one connector stem 304 extending from the first connector housing 302. Each connector stem 304 includes a central communication contact 310 and at least one outer communication contact 320 supported by the central communication contact 310. Each communication contact 310, 320 is insulated from the other with an insulator 330. In some implementations, the communication contacts 310, 320 of each connector stem 304 of the first connector 300 are concentric with each other along a longitudinal axis 305 defined by the connector stem 304. In some examples, each connector stem 304 is substantially conically or hemi-spherically shaped. The shaped surfaces may have two different sizes to prevent the connectors 300,400 from being assembled incorrectly or backwards.

Referring to FIG. 9, the second connector 400 includes a second connector housing 402 defining at least one receptacle 404 configured to receive the corresponding connector stem 304 of the first connector 300. In some examples, the receptacle 404 is substantially conically shaped. A central communication contact 410 is supported by the second connector housing 402 in each receptacle 404 and is configured to receive the central communication contact 310 of the corresponding connector stem 304 of the first connector 300. At least one outer communication contact 420 is supported by the second connector housing 402 in each receptacle 404 and is configured to receive the outer communication contact 320 of the corresponding connector stem 302 of the first connector 300. At least one magnet 440 is supported by the second connector housing 402 and is configured to magnetically retain the second connector 400 to the first connector 300. In one implementation, the magnet 440 magnetically adheres to the magnetically attractable first connector housing 302 to hold the second connector 400 to the first connector 300. The magnet 440 may serve as a channel of communication to the first connector 300.

In each communication connector assembly 1, 2, 40, 50, 60 the magnet 220, 440 may include multiple small magnets (e.g. six magnets seeded axially around the second connector housing), a ring magnet, a hemi-circular magnet, or other magnet with a flat, rippled, contoured, or other exposed surface.

In some examples, the communication contacts 410, 420 of each receptacle 404 of the second connector 400 are concentric with each other along a longitudinal axis 405 defined by each receptacle 404.

The central communication contact 410 of each receptacle 404 of the second connector 400, in some instances, includes a contact head 412 configured to receive the central communication contact 310 of a corresponding connector stem 304 of the first connector 300 and a contact spring 414. The contact spring 414 engages the contact head 412 against the central communication contact 310 of the mating connector stem 304, thereby maintaining communication contact between the two and allowing relatively looser tolerances in the communication connector assembly 20. Both the contact head 412 and spring 414 are retained in the corresponding receptacle 404 of the second connector housing 402.

In some examples, the first connector 300 or the second connector 400 is electricity joined to a male universal serial bus (USB) connector. The USB connector may use two two-pole conical connectors, for example.

In some applications, the first connector 300 may have multiple connector stems 304 which each have a different geometry (e.g. height, shape, diameter, or cone size) that corresponds to receptacles 404 of the second connector 400 to guide a proper orientation of the first connector 300 and the second connector 400 with respect to each other.

In examples using a conically shaped first connector 100 or connector stem 304 (or other slanted shape), the conical (or slanted) shape provides indexing of the communication contacts 110, 120, 140, 310, 320, 340 by using a plurality of concentric rings that form the cone shape first connector 100 or connector stem 304 with or without a contact at the center of the cone or at the base on the cone, enabling an extremely compact design.

The magnetic temporary retention of the second connector 200, 400 to the first connector 100, 300 allows a quick break away of each connector due to sudden impacts or non-axial loading. Implementations using a conically shaped first connector 100 or connector stem 304 provide less resistance to non-axial loading before a break away occurs.

The communication contacts 110, 120, 140, 310, 320, 340 of the communication connector assembly 1, 2, 40, 50, 60 may include electrical contacts, optical contacts, or other types joining communication.

Implementations of the communication connector assembly 1, 2, 40, 50, 60 as a multi-pole power connector adapter may be used for applications including, but not limited to: notebook computers, portable electronic devices, and any other multi-pole electronic devices. Implementations of the communication connector assembly 1, 2, 40, 50, 60 as an audio connector adapter may be used for applications including, but not limited to: headphones, microphones, speakers, patch cables, and other mono and stereo adapters. Implementations of the communication connector assembly 1, 2, 40, 50, 60 as a data connector adapter may be used for applications including, but not limited to: universal serial bus, network, fire wire, coaxial, serial, monitor, and other data adapters.

A number of implementations have been described. Nevertheless, it will be understood that various modifications may be made without departing from the spirit and scope of the disclosure. For example, other slanted geometries may be used for the first connector 100, connector stem 304, and second connector receptacles 204, 404. Accordingly, other implementations are within the scope of the following claims.

What is claimed is:

1. A communication connector assembly comprising:
a first connector comprising:
a first connector body; and
at least one communication contact supported by the first connector body; and
a second connector configured to receive the first connector and comprising:
a second connector body defining a contact surface configured to receive the first connector;
at least one communication contact supported by the second connector body and configured to receive the corresponding communication contact of the first connector; and
at least one magnet supported by at least one of the first and second connector bodies and configured to magnetically retain the first and second connector bodies together.

2. A communication connector assembly comprising:
a first connector comprising:
a central communication contact; and
an outer communication contact supported by the central communication contact; and
a second connector configured to receive the first connector and comprising:
a second connector body defining a receptacle configured to receive the first connector;
a central communication contact supported by the second connector body in the receptacle and configured to receive the central communication contact of the first connector; and
at least one magnet supported by the second connector body and configured to electrically contact the outer communication contact of the first connector, the magnet magnetically retaining the second connector to the first connector.

3. The communication connector assembly of claim 2 wherein the communication contacts of the first connector are concentric with each other along a longitudinal axis defined by the first connector.

4. The communication connector assembly of claim 2 wherein the communication contacts of the receptacle of the second connector are concentric with each other along a longitudinal axis defined by the receptacle.

5. The communication connector assembly of claim 2 wherein the communication contacts comprise electrical contacts.

6. The communication connector assembly of claim 2 wherein the communication contacts comprise optical contacts.

7. The communication connector assembly of claim 2 wherein the first and second connectors each further comprise:
at least one middle contact;
wherein the middle communication contact of the first connector is supported by the central contact and insulated from the other communication contacts of the first connector; and
wherein the middle communication contact of the second connector is supported by the second connector body, configured in the receptacle to receive the corresponding middle communication contact of the first connector, and insulated from the other communication contacts of the second connector.

8. The communication connector assembly of claim 7 wherein the communication contacts of the first connector are concentric with each other along a longitudinal axis defined by the first connector.

9. The communication connector assembly of claim 7 wherein the communication contacts of the second connector are concentric with each other along a longitudinal axis defined by the receptacle of the second connector.

10. The communication connector assembly of claim 2 wherein the central communication contact of the second connector comprises:
a contact head configured to receive the central communication contact of the first connector; and
a contact spring engaging the contact head, both the contact head and spring retained by the second connector body.

11. The communication connector assembly of claim 2 wherein the first connector is substantially conically shaped.

12. The communication connector assembly of claim 2 wherein the first connector is substantially hemi-spherically shaped.

13. The communication connector assembly of claim 2 further comprising an audio adaptor electricity joined to at least one of the first connector or the second connector.

14. The communication connector assembly of claim 2 further comprising a universal serial bus connector electricity joined to at least one of the first connector or the second connector.

15. A communication connector assembly comprising:
a first connector comprising:
a magnetically attractable first connector housing;
at least one connector stem extending from the first connector housing and comprising:
a central communication contact; and
at least one outer communication contact supported by the central communication contact, each communication contact of the first connector insulated from the other; and
a second connector configured to receive the first connector and comprising:
a second connector housing defining at least one receptacle configured to receive the corresponding connector stem of the first connector;
a central communication contact supported by the second connector housing in each receptacle and configured to receive the central communication contact of the corresponding connector stem of the first connector;
at least one outer communication contact supported by the second connector housing in each receptacle and configured to receive the outer communication contact of the corresponding connector stem of the first connector, each communication contact of the second connector insulated from the other; and
at least one magnet supported by the second connector housing and configured to magnetically retaining the second connector to the first connector.

16. The communication connector assembly of claim 15 wherein the communication contacts of each connector stem of the first connector are concentric with each other along a longitudinal axis defined by the connector stem of the first connector.

17. The communication connector assembly of claim 15 wherein the communication contacts of each receptacle of the second connector are concentric with each other along a longitudinal axis defined by the receptacle of the second connector.

18. The communication connector assembly of claim 15 wherein the communication contacts comprise electrical contacts.

19. The communication connector assembly of claim 15 wherein the communication contacts comprise optical contacts.

20. The communication connector assembly of claim 15 wherein the central communication contact of each receptacle of the second connector comprises:
a contact head configured to receive the central communication contact of the corresponding connector stem of the first connector; and
a contact spring engaging the contact head, both the contact head and spring retained by the second connector housing.

21. The communication connector assembly of claim 15 wherein each connector stem of the first connector is substantially conically shaped.

22. The communication connector assembly of claim 15 wherein each connector stem of the first connector is substantially hemi-spherically shaped.

23. The communication connector assembly of claim 15 further comprising an audio adaptor electricity joined to at least one of the first connector or the second connector.

24. The communication connector assembly of claim 15 further comprising a universal serial bus connector electricity joined to at least one of the first connector or the second connector.
